(19) United States
(12) Patent Application Publication
(10) Pub. No.: US 2019/0006098 A1
(43) Pub. Date: Jan. 3, 2019

(54) NEAR NET SHAPE MANUFACTURING OF MAGNETS

(71) Applicant: GM GLOBAL TECHNOLOGY OPERATIONS LLC, DETROIT, MI (US)

(72) Inventor: Yucong Wang, West Bloomfield, MI (US)

(21) Appl. No.: 15/637,028

(22) Filed: Jun. 29, 2017

(51) Int. Cl. H01F 41/02; H01F 1/053; H01F 1/057

(52) U.S. Cl. CPC H01F 41/0266; H01F 1/0536; H02K 1/02; H01F 1/057; H01F 41/0293

(57) ABSTRACT

A magnet and a method of near net shape forming the magnet are provided. The method includes printing a plurality of layers of magnetic powder material, layer by layer, to form the magnet having a three-dimensional shape and sintering the plurality of layers of magnetic powder material to harden the magnet. The method may also include applying a magnetic field to the magnetic powder material while printing the plurality of layers of magnetic powder material to orient the magnetic powder material in a desired direction.

### FIELD

The present disclosure relates generally to permanent magnets and methods of forming permanent magnets, which may be used in electric motors.

### INTRODUCTION

Permanent magnets have been widely used in a variety of devices, including traction electric motors for hybrid and electric vehicles, wind mills, air conditioners and other mechanized equipment. Such permanent magnets may be ferrite, Nd—Fe—B, CmCo, CmFeN, Alnico etc.

For Nd—Fe—B magnets, the manufacturing processes begin with the initial preparation, including inspection and weighing of the starting materials for the desired material compositions. The materials are then vacuum induction melted and strip cast to form thin pieces (less than one mm) of several centimeters in size. This is followed by hydrogen decrepitation, where the thin pieces absorb hydrogen at about 25° C. to about 300° C. for about 5 to about 20 hours, dehydrogenated at about 200° C. to about 400° C. for about 3 to about 25 hours, and then subjected to hammer milling and grinding and/or mechanical pulverization or nitrogen milling (if needed) to form fine powder suitable for further powder metallurgy processing. This powder is typically screened for size classification and then mixed with other alloying powders for the final desired magnetic material composition, along with binders to make green parts (typically in the form of a cube) through a suitable pressing operation in a die. In one form, the powder is weighed prior to its formation into a cubic block or other shape. The shaped part is then vacuum bagged and subjected to isostatic pressing, after which it is sintered (for example, at about 800° C. to about 1100° C. for about 1 to about 30 hrs in vacuum) and aged, if needed, (for example, at about 300° C. to about 700° C. for about 5 to about 20 hours in vacuum). Typically, a number of blocks totaling about 100 kg to about 800 kg undergo sintering at the same time as a batch.

The magnet pieces are then cut and machined to the final shape from the larger block based on the desired final shape for the magnets. The magnet pieces are then surface treated, if desired. A cutting machine having numerous thin blades is used to cut desired shapes from the magnet block. Much of the material is lost in the cutting operation. The cutting and machining process to create the magnets having the desired shape typically results in a relatively large amount of material loss, where the yield is typically about 55 to 75 percent (i.e., about 25 to 45 percent loss of the material).

The high material loss during manufacturing has greatly increased the cost of the finished rare earth element magnets. This cost has been exacerbated by a dramatic rise in the price of the raw rare earth metals in the past several years. As such, there are significant problems associated with accurately producing cost-effective magnets that contain rare earth materials.

### SUMMARY

The present disclosure provides a novel method of producing magnets that includes printing magnetic powder material into a desired final shape of the magnet by printing a series of thin layers of magnetic powder material into a three-dimensional shape that does not require the magnet to be machined into another final shape. This results in a savings of material that is typically lost through the cutting and machining process of the magnet.

In one form, which may be combined with or separate from the other forms disclosed herein, a method of near net shape forming a magnet is provided. The method includes printing a plurality of layers of magnetic powder material, layer by layer, to form the magnet having a three-dimensional shape. The method then includes sintering the plurality of layers of magnetic powder material to harden the magnet.

In another form, which may be combined with or separate from the other forms disclosed herein, this disclosure provides a magnet containing a plurality of layers of magnetic powder material that have been sintered together to harden the plurality of layers into the single magnet having a desired shape.

Additional features may be provided, including but not limited to the following: the method including a step of applying a magnetic field to the magnetic powder material while printing the plurality of layers of magnetic powder material to substantially orient the magnetic powder material in a desired direction; the step of printing the plurality of layers of magnetic powder material comprising printing a first plurality of layers that includes a binder material and printing a second plurality of layers that is free of binder material; the step of printing the plurality of layers of magnetic powder material comprising alternating first layers of the plurality of first layers with second layers of the plurality of second layers; the binder material being provided as a polymer-based, non-magnetic material configured to enable adherence together of powder particles of the magnetic powder material; the step of sintering being performed at a sintering temperature; the method further comprising heating the plurality of layers of magnetic powder material at a hardening temperature prior to the step of sintering; the hardening temperature being lower than the sintering temperature; the hardening temperature being provided as less than or equal to 400 degrees C.; the sintering temperature being provided in the range of about 750 to about 1100 degrees C.; subjecting the magnet to an additional hot isostatic press (HIP) process; providing the magnetic powder material comprising at least one rare earth metal; providing the magnetic powder material comprising neodymium, iron, and boron; providing the magnetic powder material comprising at least one of dysprosium and terbium; and the step of printing a plurality of layers of magnetic powder material including printing the plurality of layers into a desired final shape of the magnet.

In addition, the present disclosure provides a magnet formed by any version of the methods disclosed herein. The magnet may comprise at least one rare earth metal, the magnet may comprise neodymium, iron, and boron, and/or the magnet may comprise dysprosium and/or terbium.

### BRIEF DESCRIPTION OF THE DRAWINGS

The drawings are provided for illustration purposes only and are not intended to limit this disclosure or the claims appended hereto.

FIG. 1A is a plan view of an exemplary magnet, in accordance with the principles of the present disclosure;

FIG. 1B is a perspective view of the magnet of FIG. 1A, according to the principles of the present disclosure;

FIG. 1C is a cross-sectional side view of a portion of the magnet of FIGS. 1A-1B, taken along the line 1C-1C in FIG. 1B, in accordance with the principles of the present disclosure;

FIG. 2 is a block diagram illustrating a method of near net shape forming a magnet, according to the principles of the present disclosure; and

FIG. 3 is a block diagram illustrating the method of FIG. 2, with additional optional steps, in accordance with the principles of the present disclosure.

### DETAILED DESCRIPTION

The present disclosure provides a permanent magnet and a process for making permanent magnets in such a way that material loss is reduced. The process greatly reduces or eliminates the need for subsequent machining operations.

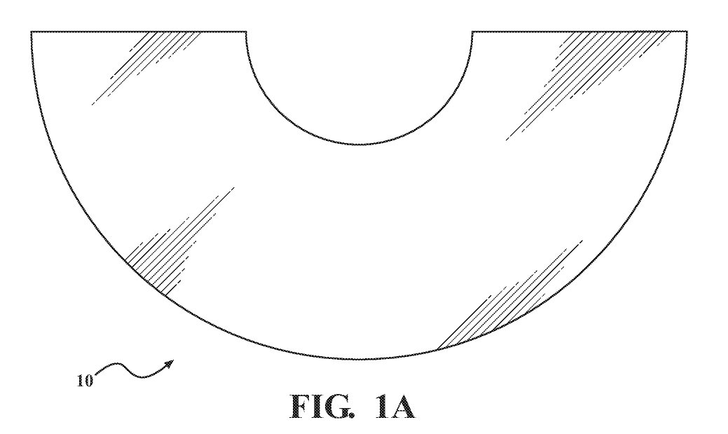

Referring now to FIG. 1A, a permanent magnet is illustrated and generally designated at 10. In this variation, the permanent magnet 10 has a three-dimensional half-annulus shape with a thickness t; however, it should be understood that the permanent magnet 10 could have any other desired shape, without falling beyond the spirit and scope of the present disclosure. The permanent magnet 10 could be useful in electric motors and the like, or in any other desired application.

The magnet 10 may be a ferromagnetic magnet, having an iron-based composition, and the magnet 10 may contain any number of rare earth metals. For example, the magnet 10 may have a Nd—Fe—B (neodymium, iron, and boron) configuration. The magnet may also contain Dy (dysprosium) and/or Tb (terbium), if desired.

Referring now to FIG. 1C, the permanent magnet 10 is formed from a plurality of layers 12 of magnetic powder material. Each of the layers 14a, 14b of the plurality of layers 12 is created by 3D-printing the layers 14a, 14b contiguously, layer by layer, to form the shape of the permanent magnet 10. Thus, the magnet 10 is printed, one layer 14a, 14b at a time, into substantially the final net shape desired. The layers 14a, 14b may be printed using a printing device, such as a three-dimensional metal printer, that is capable of printing magnetic powder material layers.

Each layer may have a height or thickness in the range of about 5-500 micrometers; for example, each layer may have a height of about 10 micrometers. As such, the magnet 10 may have a large plurality of layers, such as 300 layers, resulting in a magnet that has a thickness t of about 3 mm, by way of example. Other thicknesses t could be in the range of about 1 to about 10 mm for electric motors, or any other desired magnet thickness t. Magnets used in wind mills are much bigger.

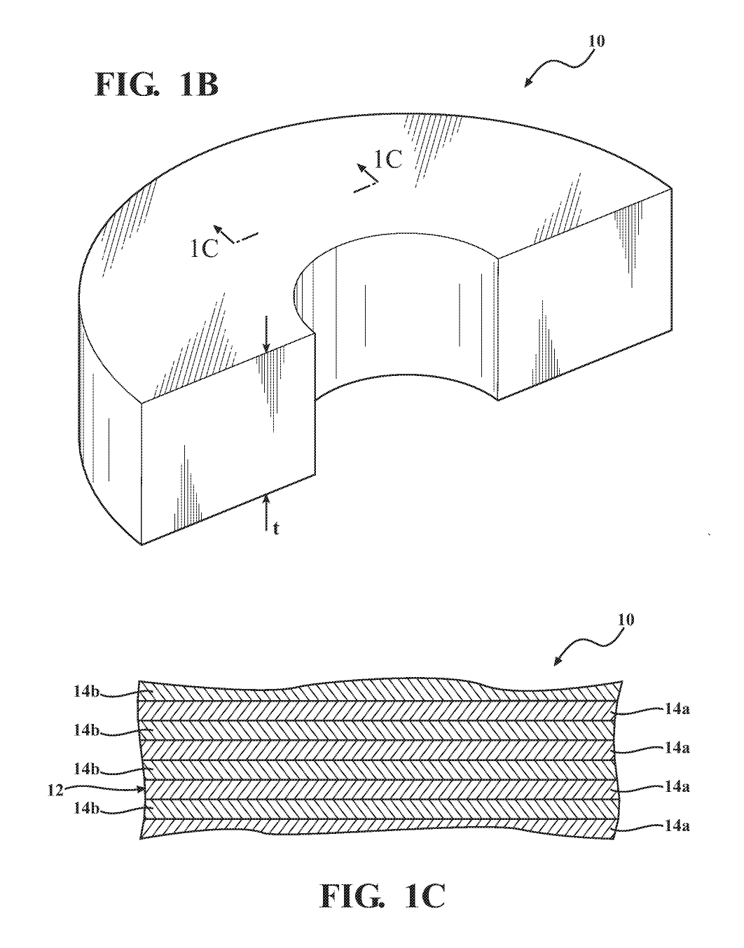

Referring now to FIG. 2, the present disclosure provides a method 100 of near net shape forming a magnet, such as the magnet 10. The method 100 includes a step 102 of printing a plurality of layers 12 of magnetic powder material, layer by layer, to form the magnet 10 having a three-dimensional shape. The method 100 further includes a step 104 of sintering the plurality of layers 12 of magnetic powder material to harden the magnet 10.

A small amount of a binder material, which may be organic or inorganic, may be present in some of the layers of the plurality of layers 12. The binder material may assist with holding the magnet powder material together until heat treated and/or sintered. The binder material may be a polymer-based, non-magnetic material configured to enable adherence together of powder particles of the magnetic powder material. The binder material may be organic or inorganic. The binder may be applied to magnet powder layer by layer (one layer binder and then one layer of magnet powder), or premixed with magnet powder and then printed layer by layer (one layer of non-coated magnet powder and one layer of binder coated magnet powder).

Binder material is generally undesirable due to cost or other side effects, so the binder material may not be present in every layer of the plurality of layers 12. Instead, the binder material may be used by pre-coating the magnet powder that is used to make alternate layers 14a, but not all of the layers 12. Thus, in some examples, the step 102 of printing the plurality of layers 12 of magnetic powder material comprises printing a first plurality of layers 14a that includes a binder material and printing a second plurality of layers 14b that is free of binder material. The layers 14a that include binder material may be alternated with the layers 14b that are free of binder material (the layers 14b that do not contain binder material). The magnetic powder material may be printed as separate layers from a binder material layer. In still other forms, every layer 14a could contain binder material, if desired.

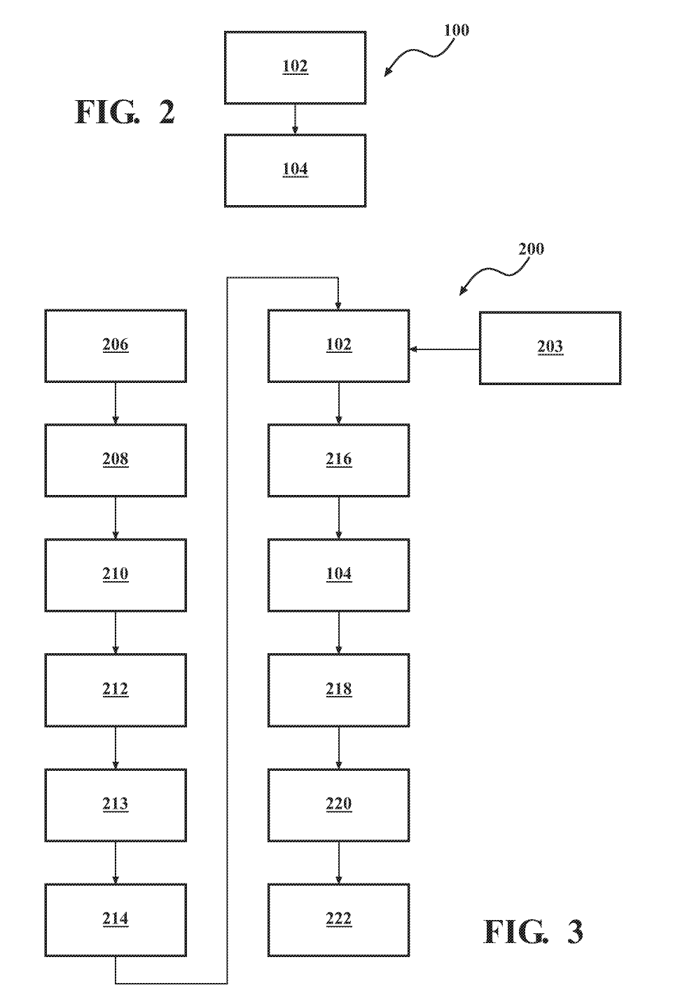

Referring now to FIG. 3, a method 200 is illustrated for forming a near net shape permanent magnet 10, which includes the steps 102, 104 shown in FIG. 2, along with additional steps 206, 208, 210, 212, 213, 214, 203, 216, 218, 220, 222 that may be included. Thus, the method 200 begins with a step 206 of initial preparation, including inspection and weighing of the starting materials for the desired material compositions. The method 200 then proceed to a step 208 of vacuum induction melting and strip casting of the starting materials to form thin pieces (less than one mm) of several centimeters in size. This step 208 is followed by a step 210 of hydrogen decrepitation, where the thin pieces absorb hydrogen at about 25° C. to about 300° C. for about 5 to about 20 hours and then are dehydrogenated at about 200° C. to about 400° C. for about 3 to about 25 hours.

The method 200 then proceeds to a step 212 of pulverization, which may include hammer milling and grinding and/or mechanical pulverization or nitrogen milling (if needed) to form fine powder suitable for further powder metallurgy processing.

In a step 213, the method 200 includes maxing middling powder, milling, and mixing fine powder. This step 213 may include blending 10 various constituent powders that correspond to the number of materials needed to make up the magnet. For example, if the magnet 10 is being produced is based on a Nd—Fe—B configuration where at least some of the Nd is to be replaced by Dy or Tb, constituent powders may include the aforementioned iron-based powder containing Dy or Tb, as well as an Nd—Fe—B-based powder. In one form, such as for car or truck applications involving traction motors, the finished rare earth permanent magnets will have Dy by weight about 8 or 9 percent. In other applications, such as wind turbines, the bulk Dy or Tb concentration may need to be on the order of 3 to 4 percent by weight. In any event, the use of permanent magnets in any such motors that could benefit from improved magnetic properties (such as coercivity) are deemed to be within the scope of the present disclosure. Additional constituents—such as the binders referred to above—may also be included into the mixture produced by blending, although such binders should be kept to a minimum to avoid contamination or reductions in magnetic properties. In one form, the blending may include the use of an iron-based alloy powder of Dy or Tb (for example, between about 15 percent and about 50 percent by weight Dy or Tb) being mixed with an Nd—Fe—B-based powder.

In a step 214, the powder is screened for size classification and then mixed with other alloying powders for the final desired magnetic material composition, along with binders (if desired, as explained above).

Thereafter, the plurality of layers 12 of magnet powder material are printed, such as by a three-dimensional printer, in step 102, as explained above. As described above, the step 102 of printing the plurality of layers 12 may include printing the plurality of layers 12 into a desired final shape of the magnet, with little cutting and machining required thereafter.

The method 200 may include a step 203 of applying a magnetic field to the magnetic powder material while printing the plurality of layers of magnetic powder material to substantially orient the magnetic powder material in a desired direction to create an anisotropic magnet. Thus, the magnetic powder material is aligned under a magnetic field, which may be in the range of about 0.5 to 4 Tesla, and preferably about 2 Tesla. The magnetic field will cause the individual magnetic particles of the mixture to align so that the finished magnet 10 will have a preferred magnetization direction. Thus, the magnet powder material may be provided in an anisotropic orientation.

The printed layers 12 may be heated in a hardening step 216 to a hardening temperature that is lower than the sintering temperature. For example, the hardening temperature may be less than 400 degree C. Through layer by layer, the hardening step 216 is performed to melt the binder materials and thereby harden the plurality of layers 12 enough so that the magnet 10 can be held and shaken out to release any loose powder before sintering the magnet 10. In other words, the hardening step 216 may result in “hardened green parts” or “brown parts” that are still not in final strength and microstructure because they should preferably undergo sintering to fully harden them. After the hardening step 216, the magnet 10 is slightly hardened, but not as hard as the magnet 10 becomes after sintering.

After the hardening step 216, the method 200 proceeds to the sintering step 104. In the sintering step 104, the magnet 10 is sintered at a temperatures in the range of about 750 to about 1100 degrees C. The sintering may be performed 1in vacuum for about 1 to about 30 hours and aged, if needed, another heat treatment may be performed at about 300 degrees C. to about 700 degrees C. for about 3 to about 20 hours in vacuum. In addition, a HIPping may be applied to increase magnet density, or minimize porosity.

Sintering can be performed in vacuum or in an inert atmosphere (for example, N₂ or Ar) to prevent oxidation. Typical sintering vacuum is in the range of about 10⁻³ and about 10⁻⁵ Pascals to achieve up to 99 percent theoretical density. Longer sintering times can further improve the sintered density. If the sintering time is too long, it may negatively impact both mechanical and magnetic properties due to over grown grains in microstructure. As with other forms of powder metallurgy processing, a cooling schedule may be used, where the sintered component is cooled over the course of numerous hours. Sintering 104 may also include subjecting the layers 12 to a SiC heating element and high-powered microwaves.

Sintering is used to promote metallurgical bonding through heating and solid-state diffusion. As such, sintering—where the temperature is slightly below that needed to melt the magnetic powder material—is understood as being distinct from other higher temperature operations that do involve melting of the powder material.

Additional secondary operations after the sintering may also be employed, including machining as well as other steps (not shown) including repressing, coining, sizing, deburring, surface compressive peening, joining, tumbling or the like.

After the step 104 of sintering, the method 200 may include subjecting the magnet 10 to a hot isostatic press (HIP) process in step 218. In an alternative configuration, the step 218 could include hot forging instead of the HIP process. Thereafter, the method 200 may include a step 220 of minor machining, such as polishing (such as with ceramic or metallic powder, for example) and/or grinding, if desired.

The method 200 may also include a surface treatment step 222 before sintering or heat treatment. The surface treatment step 222 may include, for example, the addition of an oxide or related coating in certain situations. For example, a protective layer or coating may be added. The protective coating may be applied after the sintering step 104 as shown in FIG. 3, or in the alternative, the protective coating may be applied at a different time, such as before the sintering step 104. In one form, the protective coating may be a ceramic coating configured to have high thermal insulation and oxidation-resistant properties. For example, a slurry made up of a mixture of ceramic and mineral particles suspended in an organic-based (for example, ethanol or acetone) solution of sodium silicate may be used. The coating may be a temporary coating that may be removed (such as by blasting or the like) after the sintering step 104. Although the compound making up the protective layer is mentioned as containing sodium silicate, it will be appreciated by those skilled in the art that other ceramic-like substance that exhibits inert behavior at sintering temperatures may be used; a few such examples are aluminum oxide or dysprosium sulfide. Furthermore, some of the coating compositions could be permanently left on the magnets as an oxidation-resistance protective coating.

The methods 100, 200 described above may be utilized to provide a magnet 10 containing a plurality of layers 12 of magnetic powder material that has been sintered together to harden the plurality of layers into the single magnet having a desired shape.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

It will be apparent that modifications and variations are possible without departing from the scope of the invention defined in the appended claims. More specifically, although some aspects of the present disclosure are identified herein as preferred or particularly advantageous, it is contemplated that the present invention is not necessarily limited to these preferred aspects of the invention.

What is claimed is:

1. A method of near net shape forming a magnet, the method comprising:
printing a plurality of layers of magnetic powder material, layer by layer, to form the magnet having a three-dimensional shape; and
sintering the plurality of layers of magnetic powder material to harden the magnet.

2. The method of claim 1, further comprising applying a magnetic field to the magnetic powder material while printing the plurality of layers of magnetic powder material to substantially orient the magnetic powder material in a desired direction.

3. The method of claim 2, wherein the step of printing the plurality of layers of magnetic powder material comprises printing a first plurality of layers that includes a binder material and printing a second plurality of layers that is free of binder material.

4. The method of claim 3, wherein the step of printing the plurality of layers of magnetic powder material comprises alternating first layers of the plurality of first layers with second layers of the plurality of second layers.

5. The method of claim 4, wherein the binder material is provided as a polymer-based material configured to enable adherence together of powder particles of the magnetic powder material.

6. The method of claim 3, wherein the step of sintering is performed at a sintering temperature, the method further comprising heating the plurality of layers of magnetic powder material at a hardening temperature prior to the step of sintering, the hardening temperature being lower than the sintering temperature.

7. The method of claim 6, wherein the hardening temperature is provided as less than or equal to about 400 degrees C., and the sintering temperature is provided in the range of about 750 to about 1100 degrees C.

8. The method of claim 7, further comprising subjecting the magnet to a hot isostatic press (HIP) process.

9. The method of claim 3, further comprising providing the magnetic powder material comprising at least one rare earth metal.

10. The method of claim 9, further comprising providing the magnetic powder material comprising neodymium, iron, and boron.

11. The method of claim 10, further comprising providing the magnetic powder material comprising at least one of dysprosium and terbium.

12. The method of claim 1, wherein the step of printing a plurality of layers of magnetic powder material includes printing the plurality of layers into a desired final shape of the magnet.

13. The method of claim 1, further comprising providing the magnet powder material in an anisotropic orientation.

14. A magnet formed by the method of claim 1.

15. A magnet formed by the method of claim 2.

16. A magnet containing a plurality of layers of magnetic powder material that has been sintered together to harden the plurality of layers into the magnet having a desired shape.

17. The magnet of claim 16, wherein the magnet has an anisotropic orientation.

18. The magnet of claim 17 comprising at least one rare earth metal.

19. The magnet of claim 18 comprising neodymium, iron, and boron.

20. The magnet of claim 19, further comprising at least one of dysprosium and terbium.
